(19) United States
(12) Patent Application Publication
(10) Pub. No.: US 2006/0178864 A1
(43) Pub. Date: Aug. 10, 2006

(54) Automated system and method for configuring a rack assembly

(76) Inventors: Madhavi Khanijo, Tomball, TX (US); Chao-Hsien Ho, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/053,249

(22) Filed: Feb. 8, 2005

(51) Int. Cl. G06F 13/10

(52) U.S. Cl. 703/20

(57) ABSTRACT

A scheme for configuring a rack assembly. Upon selecting a rack from a catalog, whereby a pictorial representation of the rack is displayed in a workspace of a graphic display window associated with a user's computer system, one or more components are selected the catalog via a drag and drop interface, wherein each selected component is dragged by an input device associated with the computer system and dropped on the rack's representation in the workspace. As the selected components are added to the rack, a set of rules are applied to each component to automatically configure it with respect to the rack.

### BACKGROUND

High capacity server computer systems are often mounted in rack structures that typically comprise vertically elongated, floor mounted cabinet assemblies of standard sizes. The cabinet assembly conventionally used for this purpose typically includes a rectangular internal frame externally covered by removable panels. The cabinet assembly may have a front access door pivotally mounted on the front side of the cabinet assembly and typically made of a transparent material to expose various interior components of the rack assembly such as one or more servers (typically comprised of high performance computers), monitors, storage systems, power supplies, et cetera. In general, the components are vertically mounted in a rack assembly for easy accessibility as well as for connection, service and maintenance purposes.

Manual selection and configuration of rack-mountable components in a rack assembly is an exacting task. Typically, a user selects components from a catalog or technical journal, and even the basic decision of choosing among a panoply of diverse parts, possibly from different manufacturers, poses a veritable challenge. Additionally, constructing a rack assembly entails several significant ancillary tasks beyond selecting the servers, memory systems, power supplies, and other components for a functional rack solution. For example, the weight of each component must be reviewed so that the vertical placement of each component in the rack is properly coordinated from top to bottom and so that the rack as a whole is not overloaded. Simultaneously, the physical dimensions of each component in the computer system must be analyzed for the most economical selection of the rack size. Coordinating the size of the cabinet, with the proper arrangement of the components therein, is very important to ensure that the rack does not collapse or topple over, or that a component within the rack does not collapse from the overhead weight.

There are other significant ancillary concerns as well. For example, an area of concern in rack assemblies is ventilating the interior of the cabinet for the purpose of dissipating heat generated therein by the various computer components while in operation. Thus, the thermal output of each component must be reviewed so that the components that dissipate the highest amount of heat may be isolated from others as much as possible. Furthermore, the power requirements of each component must be reviewed to ensure that the electrical service is available for the entire rack system. Ultimately, if either one of these requirements is overlooked, it is possible that a component within the system would overheat leading to destruction of the component and system failure. Therefore, even though the aforementioned matters are considered ancillary concerns, each subject is vital and must be addressed for the proper configuration of a rack solution.

### SUMMARY

One embodiment is directed to a scheme for configuring a rack assembly. Upon selecting a rack from a catalog, whereby a pictorial representation of the rack is displayed in a workspace of a graphic display window associated with a user's computer system, one or more components are selected the catalog via a drag and drop interface, wherein each selected component is dragged by an input device associated with the computer system and dropped on the rack's representation in the workspace. As the selected components are added to the rack, a set of rules are applied to each component to automatically configure it with respect to the rack.

### BRIEF DESCRIPTION OF THE DRAWINGS

FIG. 1 is an exemplary network environment wherein an embodiment of the present patent disclosure may be implemented for customizing a rack assembly solution;

FIG. 2 is a flowchart of a rack configuration method according to one embodiment;

FIG. 3 is a functional block diagram of a rack configuration system according to one embodiment;

FIG. 4 is a functional block diagram associated with the rack configuration system in one mode of operation;

FIG. 5 is a functional block diagram associated with the rack configuration system in another mode of operation; and

FIGS. 6A-6C depict illustrative renditions of a “drag and drop” interface associated with the rack configuration method according to one embodiment.

### DETAILED DESCRIPTION OF THE DRAWINGS

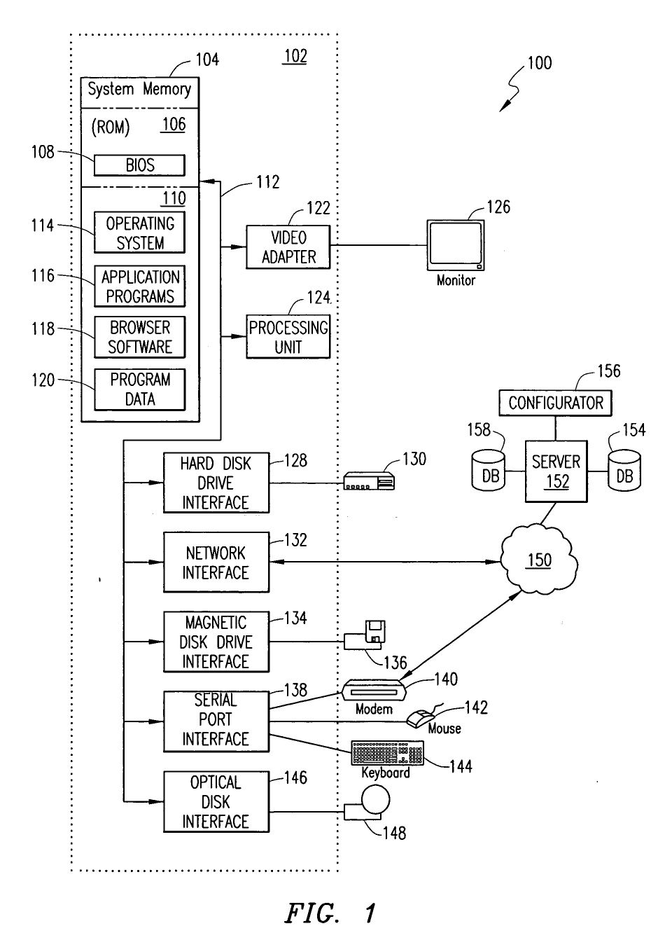

In the drawings, like or similar elements are designated with identical reference numerals throughout the several views thereof, and the various elements depicted are not necessarily drawn to scale. Referring now in particular to FIG. 1, shown therein is an exemplary network environment 100 wherein an embodiment of the present patent disclosure may be implemented for customizing a rack assembly solution. A client computer system 102 having a display monitor 126 is operably coupled to an application service provider node 152 via a network 150 that hosts an embodiment of a rack configuration application 156. Those skilled in the art should recognize that the client computer system 102 is exemplary of any computer that can access the network 150 using suitable hardware, e.g., a network interface 132 and/or a modem 140 coupled to a serial port interface 138, for launching the rack configuration application 156 in a client-server relationship. In one aspect, the network 150 is comprised of a public packet-switched network (PSN) such as the Internet wherein the rack configuration application 156 is accessible via standard web browsing.

By way of illustration, a number of hardware, software and firmware modules are provided as part of the architecture of the computer system 102 that are interconnected via a bus 112. A system memory block 104 includes a read-only memory block 106 that contains an instance of ROM-based Basic Input/Output System (BIOS) 108. A random access memory (RAM) block 110 includes an operating system (OS) instance 114, one or more application programs 116, one or more browser instances 118 and program data storage 120. One or more processing units 124 are operably coupled via the bus 112 to a plurality of hardware interfaces for supporting access to a number of I/O devices and networks. As alluded to before, the network interface 132 is operable to provide access to the PSN 150, which may be effectuated via a Local Area Network (LAN) in one implementation. In addition, a hard disk drive interface 128, a magnetic disk drive interface 134, a serial port interface 138 and an optical disk interface 146 are provided with respect to corresponding I/O devices, i.e., one or more hard disk drives 130, one or more floppy drives 136, serial devices such as modem 140, an input device 142 (e.g., a pointing device, a keypad, etc.) and a keyboard 144, as well as one or more compact disk (CD) or digital video disk (DVD) drives 148. A video adapter 122 is provided for effectuating appropriate graphic displays on the monitor 126 of the computer system 102.

As will be seen below in detail, the rack configuration application 156 of the present patent disclosure provides a convenient “drag and drop” interface to the user that facilitates automatic configuration of a rack assembly using a variety of racks and components (e.g., from the group consisting of server computers, blade servers, power supplies, display monitors, storage systems, keyboards, input/output (I/O) devices, et cetera) that are selectable from appropriate on-line catalogs. In one implementation, such on-line catalogs may be stored in a database 154 associated with the application service provider node 152. Alternatively or additionally, one or more on-line component and rack catalogs may be hosted at different nodes operated by third parties. Regardless of how the catalog databases are organized, the configurator application 156 is operable to dynamically apply a set of rules with respect to the selected components and racks as the user builds a rack assembly layout via the drag and drop interface effectuated at the client computer system. By way of illustration, the rules may comprise constraints selected from the group comprising, e.g., human ergonomic constraints, component/rack form factor constraints including placement constraints, component weight-based constraints, power consumption constraints, thermal output constraints, component functionality constraints, component compatibility constraints, among others, which may be fired at different stages of the configuration process, and may be provided as part of a rack configuration knowledge system stored in a database 158 associated with the application service provider node 152.

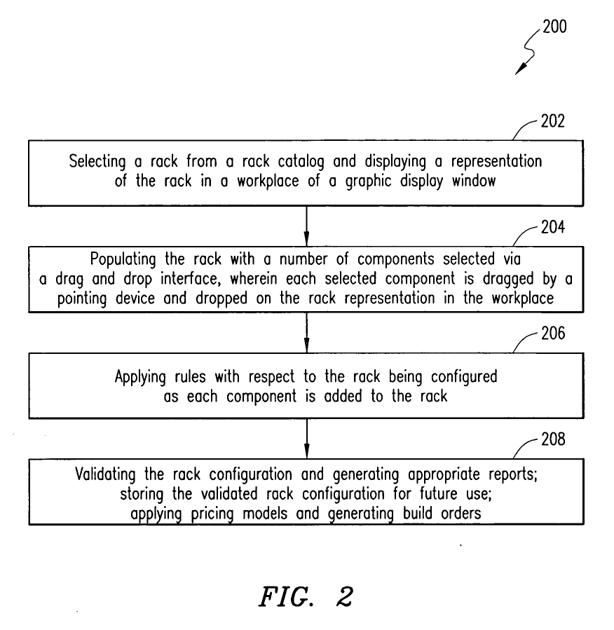

FIG. 2 is a flowchart of a rack configuration scheme 200 according to one embodiment. As illustrated, after launching the rack configurator application tool hosted at a service provider website, the user at a client computer selects a rack from a pictorial rack catalog that is displayed on a graphic display window of the computer's monitor, whereupon a pictorial representation of the selected rack is displayed in a workspace of the graphic display (block 202). The selected rack is then populated with a number of components selected via a drag and drop interface, wherein each selected component from a pictorial component catalog is dragged by the user using a pointing/input device (e.g., a mouse, a trackball, and the like) and dropped on the rack's pictorial representation displayed in the workspace (block 204). One or more rules are applied with respect to each selected component that is added via the drag and drop interface to the rack's pictorial representation (block 206). For example, when two or more servers are dragged and dropped on the rack, the lighter one is placed on top of the heavier one inside the rack cabinet because of a weight-based server placement rule. When a display monitor is added to the configuration, it is automatically placed at eye level with respect to the selected rack (e.g., placing the display monitor at around 30U to 36U in a 42U rack, 1U=1.75 inches), regardless of where the pictorial representation of the display monitor is dragged and dropped on the rack. In accordance with one embodiment, application of rules in block 206 involves placement configuration, verification, and validation of only the component that is being dropped in the workspace (i.e., invoking of component-specific rules, which may be referred to as a first set of rules). After adding the various components to the rack's pictorial representation, the rack configuration involving all the selected components is validated by a knowledge-based validator module of the rack configurator tool in order to discover if there exist any potential issues, such as additional rule violations, if any, functional errors, inter-component and sub-component compatibility/connectivity problems and warnings, et cetera (block 208). For example, rules regarding interoperability among servers, storage devices, etc., blade server rules, and the like, may be invoked in this process. Accordingly, multi-component or inter-component rules (which may be referred to as a second set of rules) are invoked at this stage. Appropriate error and warning reports may also be generated, if necessary. In one implementation, additional user input may be required when a rack configuration generates one or more errors and warnings, preferably prior to proceeding further with the configuration process. For instance, errors and warnings may be prioritized such that certain types of warnings/errors may require corrective action (by replacing one or more components, for example), whereas others may be ignored. Upon generating a validated rack configuration, the user may store the configuration using a unique rack configuration identity (ID), which may comprise an alphanumeric code, for future retrieval and use (e.g., editing). Additionally, one or more pricing models may be applied to the validated rack configuration, based on which a build order may be generated for transmission to a select manufacturer. As further options, a bill of materials may be generated and user actions may be initiated to cause the configured rack to be purchased. As illustrated in the flowchart of FIG. 2, these operations are also consolidated in block 208. Additionally, the rack catalog and component catalog portions described above may be consolidated as a single catalog in some embodiments.

Based on the foregoing, it should be appreciated that different sets of rules are fired at different stages of the rack configuration process. In block 206, for example, placement constraints, component weight-based constraints, etc. may be applied. That is, when a particular component is added, that component is positioned or configured properly within the rack in accordance with an applicable placement rule. Also, the particular component's parent-child relationship (first-order relationship) is verified with respect to at least one of the rack or other components, where the rack and its components and subcomponents (i.e., subassemblies, their constituent sub-subassemblies, and so on) are described in an XML hierarchical relationship tree (the rack being the root node in one implementation).

A second set of rules are fired during validation after all selected components are added, resulting in a rack configuration, as described above with respect to block 208. In this process, higher-order parent-child relationships among the components are verified, involving nested relationships between subassemblies, sub-subassemblies, etc. of the components. Examples of these rules include power consumption constraints, thermal output constraints, component functionality constraints, component compatibility constraints, and the like. Additionally, some of the rules that are common to both sets of rules. By way of illustration, when a server and a storage unit are added, their connectivity and relative positioning may be determined by the first set of rules (during the drag and drop process). In the validation process, internal controller subassembly of the server is verified to determine if there are enough controllers (i.e., the number) or the available controller(s) has/have sufficient capacity to control the selected storage unit. As alluded to previously, when rule violations occur either in block 206 (during drag and drop) or block 208 (during validation), appropriate error messages and/or warnings may be generated.

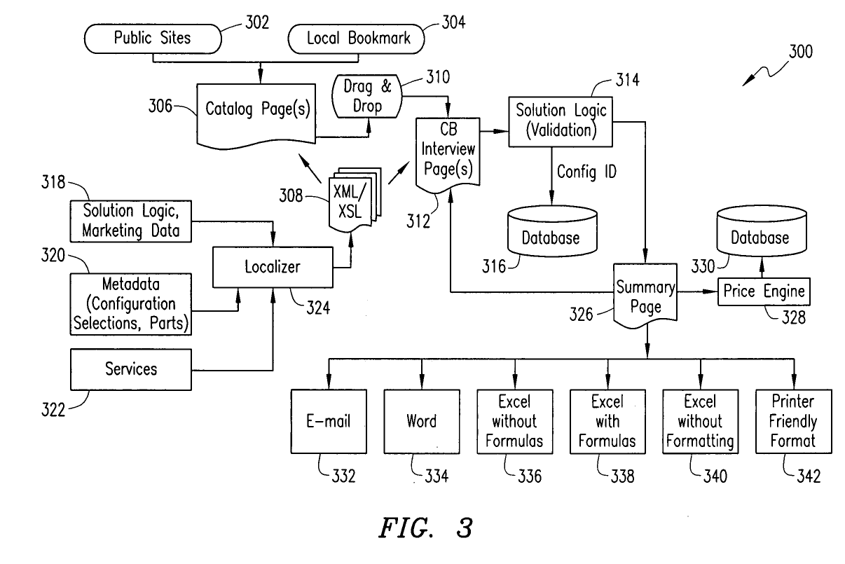

FIG. 3 is a functional block diagram of a rack configuration system 300 according to one embodiment. One or more public sites 302 are accessible via web browsing for launching an embodiment of a rack configurator tool of the present patent disclosure, which may be hosted by an application service provider as discussed in the foregoing. Alternatively or additionally, the Uniform Resource Identifiers or Locators (URIs/URLs) associated with the rack configuration application may be stored as local bookmarks 304 for launching the application. One or more catalog pages, i.e., rack catalogs and component catalogs, wherein each element (e.g., racks, servers, storage units, power supplies, monitors, etc.) is preferably pictorially represented. Associated with the catalog pages are the various attributes of the racks and components, i.e., sizes, form factors, capacities, manufacturers, prices, functional and performance specifications, and the like, that are preferably encoded in one or more markup language documents, e.g., Extensible Markup Language (XML) documents, that can be presented in multiple views via Extensible Stylesheet Language (XSL). Additionally, various sources of configuration-related data and metadata are integrated into the rack configuration system 300 using suitable XML/XSL functionality 308. As illustrated, a solution logic and marketing data module 318, a metadata module 320 relating to configuration selections and component parts, and a services module 322 relating to after-sale service agreements, warranties, renewal options, etc., are exemplary of such configuration-related data sources which are adaptively localized for different geographic regions and countries by a localizer module 324. A drag and drop interface 310 effectuated using Dynamic HyperText Markup Language (DHTML) is available for interacting with the catalog pages 306 as well as custom builder (CB) interview pages 312 by the user. Validation logic module 314 is operable to validate the selections effectuated in the interview pages 312 via the drag and drop interface 310. As alluded to before, a configuration database 316 is provided for storing the validated configurations based on a unique ID (Config ID). One or more summary pages 326 are provided for facilitating various reporting options as well as pricing with respect to the validated rack configurations. By way of example, reporting may be done via email options 332, word processing (e.g., MS-Word) options 334, spreadsheet options such as Excel without formula options 336, Excel with formula option 338 and Excel without formatting options 340, and printer-friendly format options 342. A pricing engine 328 is operable to apply suitable pricing data in a database 330 to the configuration summary data to generate pricing models relevant to the validated rack configurations.

In one embodiment, the rack configuration scheme set forth above may be implemented as a set of program code instructions on a computer-accessible medium associated with an application server node (such as the node 152 shown in FIG. 1). When executed by the application server, the program code instructions facilitate an automated system for configuring one or more rack assemblies, and preferably comprise: program code instructions for providing a drag and drop display interface to a user operating a client computer to which the application server is coupled via a computer network, wherein a graphic display window associated with the client computer includes a workspace in which a representation of a selected rack is populated by one or more components dragged and dropped by the user from a catalog display area that includes icons representative of the components; program code instructions for applying a set of rules with respect to the selected rack as each selected component is added to the selected rack's representation in the workspace; and program code instructions for validating the selected rack's configuration upon adding the selected components based on the rules. Likewise, additional program code instructions may also be provided for facilitating various other enhancements and options described in the foregoing sections.

Accordingly, it should be readily appreciated by those skilled in the art that the rack configuration scheme of the present patent disclosure provides a convenient web-based configurator with drag and drop functionality that affords worldwide customers the capability to configure complex and location-specific rack solutions without any software download or installation requirements. Any user with access to the Internet and a browser can launch the configurator tool and assemble rack solutions based on up-to-date components since the tool is directly interfaced to the configuration knowledge databases that are regularly updated.

In terms of implementation, the rack configuration system is operable to provide two modes of operation: (i) a “HELP ME BUILD” mode where a simple, guided interface allows the users to enter answers to a number of queries relating to configuration; and (ii) a “LET ME BUILD” mode that allows custom building of complex rack solutions using full drag and drop functionality. These two modes will now be described in detail immediately hereinbelow.

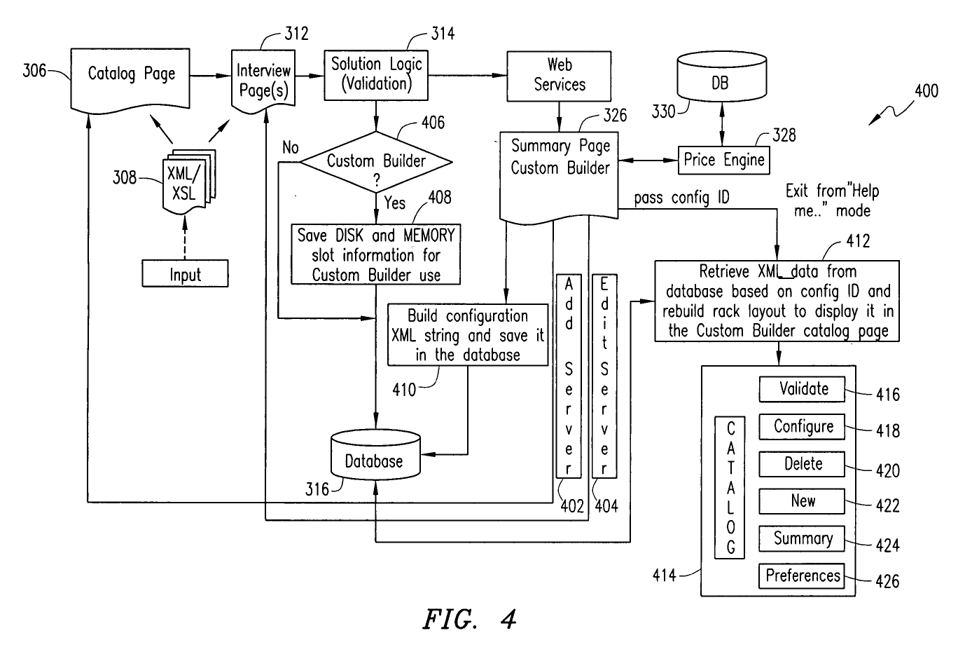

FIG. 4 is a functional block diagram 400 associated with an embodiment of the rack configuration system in the HELP ME BUILD mode of operation. As alluded to previously, customers are guided to answer a series of questions via a number of pull-down menus, such as rack catalog menu, component catalog menu, etc. Typically, the users are queried about the servers they would like to configure as well as the internal hardware selections for each selected server. The rack configuration tool then applies the rules to add appropriate rack and associated parts to the configuration, whereupon a rack layout may be presented to the user. Referring in particular to the block diagram 400, servers are added or modified by selecting server menus 402, 404. Upon validation of a rack configuration, a decision is made whether custom builder options are to be applied (block 406). If so, appropriate information is stored for custom builder use (block 408). From the summary pages 326, configuration XML strings are built and stored in the database 316. As provided in block 412, XML data may be retrieved from the database based on Config ID upon exiting from the HELP ME BUILD mode, whereby a rack layout is rebuilt and displayed on a custom builder catalog page 414. A plurality of configuration tool bar options are available via the catalog page 414 that allow drag and drop functionality in this part of the flow. A “Validate” option 416 provides valuable messages regarding the retrieved rack configuration solution, wherein the message listing includes both informational and functional messages. A “Configure” option 418 configures the selected configurable product. A “Delete” option 420 deletes any component from inside the selected rack solution. A “New” option 422 removes all selected items and starts over at the beginning of the rack building process. A summary of the components is provided by activating a “Summary” option 424. User-specified preferences that can be carried over to new configurations may be applied by activating a “Preferences” option 426. Default preferences may be automatically applied to the configuration by the custom builder. The user can accept the default settings or change them at any time during the configuration process. Those skilled in the art should recognize that these various options may be implemented as graphic icons of a tool bar in the graphic display window of the customer's computer system.

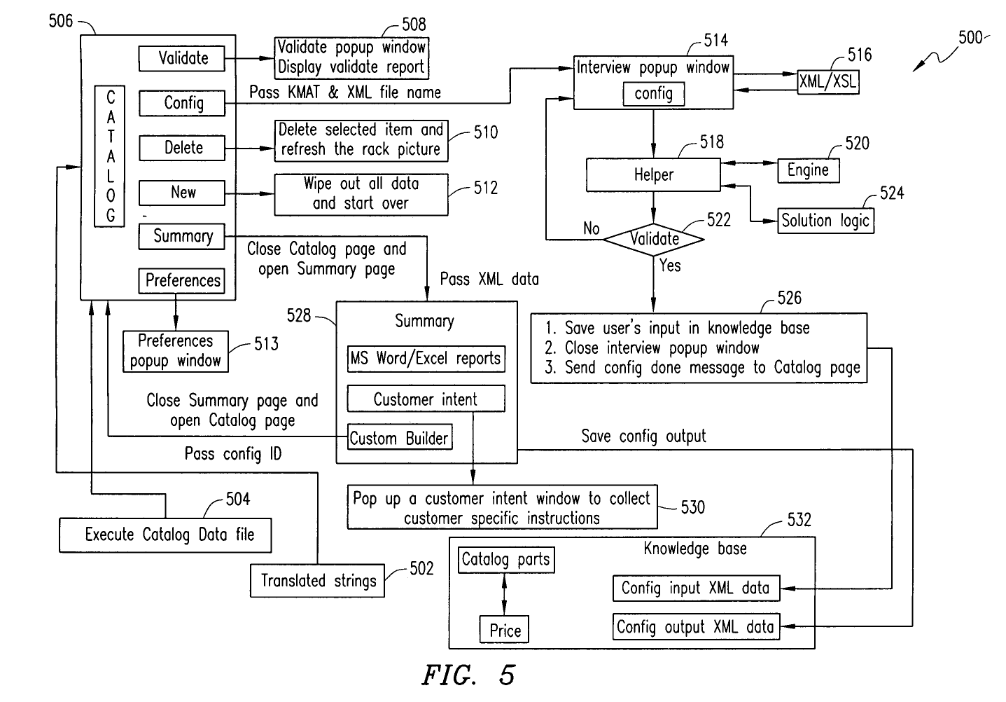

FIG. 5 is a functional block diagram 500 associated with the rack configuration system in the LET ME BUILD mode of operation wherein customers can build a rack layout by simply dragging an item from one or more catalog pages and dropping it in a graphic display workspace. A catalog page 506 is provided for activating a number of configuration tool bar options such as “Validate”, “Configure”, “Delete”, etc., essentially similar to the options described above, upon executing catalog data files (block 504) or obtaining translated configuration metadata strings (block 502). When the “Validate” option is activated, a popup window appears for displaying one or more validation reports, e.g., error and/or warning messages (block 508). The “Configure” option provides an interview popup window 514 that allows various component configuration selections via a drag and drop interface. As described above, suitable XML/XSL-based functionality 516 processes the document pages for facilitating such selections. The “Delete” option deletes the selected items and refreshes the pictorial representation of a rack solution (block 510). The “New” option clears all data for starting over (block 512). The “Summary” option provides a summary page 528 that facilitates various reporting options, customer-specific instructions (i.e., customer intent), etc. Preferably, a customer intent popup window is provided to collect any customer-specific instructions (block 530). Additionally, a customer builder option of the summary page 528 allows closing of the summary pages while the catalog page 506 is reopened and the Config ID of the rack configuration solution is passed. Finally, as pointed out in the foregoing discussion, user-specified preferences that can be carried over to new configurations may be applied by activating the “Preferences” option of the catalog page 506, which provides a popup window for entering such preferences (block 513). Custom builder preferences can be set to automatically arrange components within a rack, or turn off the auto-arrange option to custom-rack the solution.

Responsive to the user interactions in the interview popup window 514, a selected rack configuration solution is assembled within the confines of applicable rules and pricing models. These processes are illustrated in blocks 518, 520 and 524. Upon validating the configuration solution (decision block 522), a number of procedures may take place: (i) saving user's input in a knowledge base 532; (ii) closing interview popup window; and (iii) sending a “Configuration Done” message to the catalog page 506. As illustrated in the functional block diagram 500 of FIG. 5, the knowledge base 532, which includes catalog parts/components data as well as pricing data, stores the user's input as configuration input XML data. Furthermore, the configuration output from the summary page 528 is also stored as configuration output XML data in the knowledge base 532. Additionally, as alluded to in the foregoing, users may be provided with an option to generate a bill of materials, which may be used for purchasing a configured rack solution.

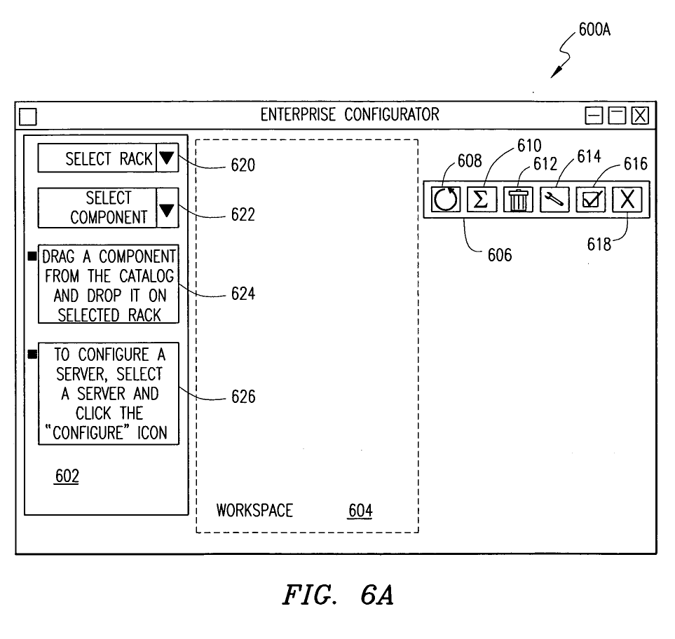

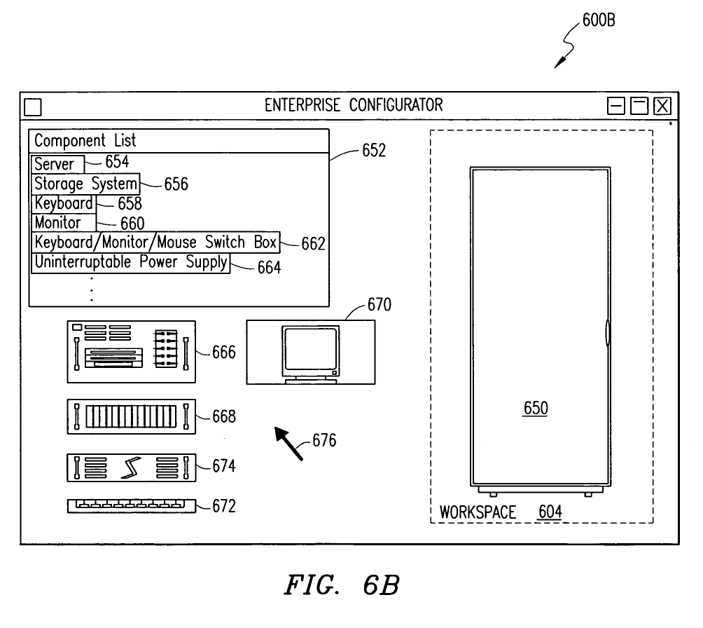

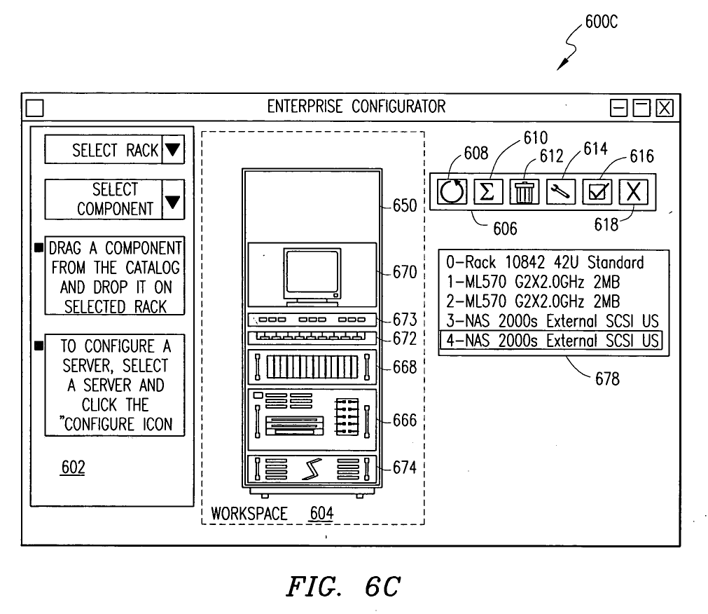

FIGS. 6A-6C depict illustrative renditions of a drag-and-drop interface associated with the rack configuration method according to one embodiment. In particular, reference numeral 600A in FIG. 6A refers to a screenshot representation of a graphic user interface displayed on a user's display monitor when the rack configurator application is launched. A selection window portion 602 of the graphic display window of the interface provides interactive capability to select one or more racks and one or more components by way of pull-down catalog options as well as the drag and drop functionality. For example, a rack catalog menu 620 may display a list of rack manufacturers, each of which may then lead to a catalog page where racks of different sizes, capacities, form factors, may be displayed by their pictorial representations. Likewise, a component catalog menu 622 can lead to successive pull-down windows where different components, parts, and elements for a rack may be selected, which may be organized in any number of ways, e.g., by manufacturer, component type, etc. As pointed out earlier, a rack may be selected by dragging its pictorial representation and dropping it in a workspace 604 of the graphic display window. Similarly, various components can be added to the selected rack by dragging and dropping their pictorial representations on the selected rack's graphic representation. Various rules are also applied as the process of drag and drop selection of the components takes place. For example, because of the application of rules such as component placement rules, rack limit rules, required parts rules, etc., the pictorial representation of the rack assembly in the workspace 604 may vary depending on the successively-added components. Configuration of a server is effectuated by activating a “Configure” icon. These processes are highlighted in option windows 624 and 626.

A configuration tool bar 606 is also provided within the graphic display window of the user interface 600A for effectuating various rack configuration tasks such as configuring, deleting, editing, et cetera, described above in reference to the two modes of operation shown in FIGS. 4 and 5. Accordingly, the tool bar 606 preferably includes a “Configure” icon 608, a “Summary” icon 610, a “Delete” icon 612, a “Preferences” icon 614, a “Validate” icon 616 and a “New” or “Start Over” icon 618.

Referring now to FIG. 6B, shown therein is a screenshot rendition 600B of the graphic user interface that highlights exemplary rack and component selections in a catalog display area. For the sake of providing an uncluttered view, no configuration tool bar options have been depicted in this screenshot rendition 600B. A component list 652 exemplifies a server catalog 654, a storage system catalog 656, a keyboard catalog 658, a display monitor catalog 660, a keyboard/monitor/mouse switch box catalog 662, and a power supply catalog 664. As each of these catalog menus is selected, a corresponding pictorial catalog including the representations of available products is displayed in a catalog display area. By way of example, pictorial representations of a server 666, a storage system 668, a display monitor 670, a keyboard 672 and a uninterrupted power supply (UPS) 674 are shown in FIG. 6B. It should be understood, however, that each product type may have its own pictorial catalog that is displayed in a separate screen and may include a large number of component representations for a like product type. That is, a server catalog may have its own separate display screen. Likewise, the other component catalogs may also have corresponding individual display screens.

Selection of a part or component is effectuated via the drag and drop functionality that allows the user to select a particular product by dragging its pictorial representation by clicking a pointing device thereon (as exemplified by a cursor arrow 676) and dropping it on the selected rack's representation 650 in the workspace 604. To ensure accurate rack configuration, the definition of devices and components may be regularly updated in the databases associated with the rack configurator application. In one implementation, the following information is provided when defining a device: (i) product name, (ii) part number, (iii) height in U (1U=1.75 inches), (iv) weight in pounds, (v) heat output in BTUs, (vi) current in Amps for low and high voltages, (vii) power usage in Watts for low and high voltages, and (viii) leakage current in mAmps for low and high voltages. Furthermore, as described in detail hereinabove, various rules are also applied as the individual components are added to the selected rack 650.

FIG. 6C depicts a screenshot rendition 600C obtained upon adding a plurality of components to the selected rack 650. As illustrated, the selected components include server 666, storage system 668, display monitor 670, keyboard 672 and keyboard/monitor/mouse switch box 673, and UPS 674. Because of the applicable rack configuration rules, UPS 674 is placed in the rack 650 at the bottom, the display monitor 670 is placed at eye level, the keyboard 672 is placed at a level that is comfortable to the user, regardless of where they may have been dropped on the rack representation 650. After adding the selected components, the various configuration icons of the tool bar 606 may be activated to generate reports, effect new configurations (e.g., adding extra racks or additional components), validate current selections, etc. A shopping cart window 678 highlights the various parts of the selected rack configuration solution.

To facilitate export of a validated rack configuration solution to a number of entities, e.g., manufacturing sites, sales/marketing sites, service order and order fill sites, and so on, appropriate interfaces may be added to the graphic display window. For example, a telephone icon may added to the display window for placing a phone order at a manufacturer's contact center. Additionally, the rack configuration solution may be processed through a recursive XML schema in order to render the rack configuration cross-platform compatible. Essentially, each part in a rack configuration solution is described in a parent-child relationship with respect to the remaining parts, wherein the parent-child relationship may comprise a hierarchical tree of unknown depth. The XML processing progresses down the tree starting from the root node, processing each intermediary node until arriving at the leaf nodes. The following is a list of attributes for each tag defined in an XML-rendered rack solution: id (a unique identifier), parentid (the identifier of the parent node), top (top coordinate relative to the top coordinate of the parent node), left (left coordinate relative to the left coordinate of the parent node), orientation (vertical or horizontal layout), height, weight, image (the image attribute can be extended if considering different views such as front view, back view, etc.), BTUs, Watts, slot (slot number of disk, memory, or network, etc.), and view (for specifying the various views, e.g., front, back, or side view). Preferably, each tag also includes the following elements: part number, description, and price.

For example, in considering a server in an exemplary rack configuration solution, the rack is the parent node of the server node, and any internal hardware parts of the server such as processors, disks, memory, etc., are the child nodes of the server parent node. Extending this analysis to a simple rack solution that includes a 42U rack, two servers, one keyboard and one display monitor, the following is the recursive XML output associated therewith:

| − | <parts> | |
|---|---|---|
| | − | <part id=”0” type=”rack” height=”42” weight=”250” |

watts=”0” btu=”0” top=”0” left=”0”>

| | |
|---|---|
| − | <description> |

| | <![CDATA[ 10642 hock Rack Pallet ]]> |
|---|---|
| | </description> |
| | <PN>245161-B22</PN> |
| | <retailPrice>1213</retailPrice> |
| − | <parts> |

| | |
|---|---|
| − | <part id=”1” parentid=”0” type=”server” height=”7” |

weight=”100” watts=”1056” btu=”3604” top=”0”
left=”0” orientation=”vertical”>

| | |
|---|---|
| − | <description> |

<![CDATA[ Server ML570 G2 X2.0 GHz US Server

with an Intel Xeon MP 2.0 GHz processor1MB L3
cache and a standard 512MB memory Tower
server. US only]]>

| | </description> |
|---|---|
| | <PN>325246-001</PN> |
| | <retailPrice>3915</retailPrice> |
| − | <parts> |

| | |
|---|---|
| − | <part id=”2” parentid=”1” type=”line item” |

qty=”1”>

| | |
|---|---|
| − | <description> |

```
  <![CDATA[ Intel X2.0 GHz 1MB 570G2/580G2
  Processor ]]>
</description>
<PN>325252-B21</PN>
<retailPrice>1185</retailPrice>
```

</part>

</parts>

</part>

| | |
|---|---|
| − | <part id=”3” parentid=”0” type=”server” height=”5” |

weight=”60” watts=”500” btu=”1707” top=”7”
left=”0” orientation=”vertical”>

| | |
|---|---|
| − | <description> |

```
<![CDATA[ ML350T04 X3.0 800-1M SCSI Server ]]>
  </description>
  <PN>331890-001</PN>
  <retailPrice>1407</retailPrice>
```

| | </part> |
|---|---|
| − | <part id=”4” parentid=”0” type=”rack part” |

height=”1” weight=”12” watts=”0” btu=”0”
top=”20” left-“0” Orientation=”vertical”>

| | |
|---|---|
| − | <description> |

<![CDATA[ Integ Carbon 1U US Rack KeyBrd

and Drwr ]]>

</description>
<PN>257054-001</PN>
<retailPrice>339</retailPrice>

| | </part> |
|---|---|
| − | <part id=”5” parentid=”0” type=”monitor” |

height=”10” weight=”44” watts=”83” btu=”283”
top=”30” left=”0” orientation=”vertical”>

| | |
|---|---|
| − | <description> |

<![CDATA[ V7550 17 Flat Tube Monitor V7550 NH

TCO- 2T 17 Carbon Silver Monitor Flat Tube ]

</description>
<PN>261611-003>/PN>
<retailPrice>148</retailPrice>

</part>

</parts>

The above XML rendition of the simple rack configuration solution example can now be used for different purposes. Since customers and entities may have different needs, only relevant pieces of the configuration solution may need to be rendered into an appropriate XML schema: e.g., a salesman could focus on the pricing, the manufacturing team could focus on the rack and individual server layout, etc. Furthermore, by transforming the XML schema using XSL into HTML constructs, one can quickly change any aspect of the page. Accordingly, multiple views of a single document may be created efficiently without modifying the original page.

Based on the foregoing Detailed Description, it should be appreciated that the present patent disclosure advantageously provides an automated rack configuration system and method that supports a smart, web-based scheme that includes easy-to-use drag and drop functionality for designing complex rack solutions. The import of some of the embodiments of the present disclosure becomes particularly discernible as configurable components get more advanced, in terms of functionality as well as form factor requirements. For example, an embodiment of the rack configurator tool allows a customer to position blade servers of different sizes (i.e., width) and types in a server enclosure of a selected rack, wherein each blade server can be independently configured. Also, different types of bus bars may be configured within the same rack. In addition, a rack configurator tool of the present disclosure allows users to configure “0U” parts, i.e., parts that do not occupy any additional vertical space on the rack (e.g., parts that are positioned adjacent to other “U” parts), by dragging and dropping these “0U” part strings from appropriate component catalogs to the workspace.

Although the invention has been described with reference to certain exemplary embodiments, it is to be understood that the forms of the invention shown and described are to be treated as illustrative only. Accordingly, various changes, substitutions and modifications can be realized without departing from the scope of the present invention as set forth in the following claims.

What is claimed is:

1. A method for configuring a rack assembly, comprising:
selecting a rack from a catalog and displaying a representation of said rack in a workspace of a graphic display window associated with a computer system;
populating said rack with at least one component selected from said catalog via a drag and drop interface, wherein each selected component is dragged by an input device associated with said computer system and dropped on said representation of said rack in said workspace; and
applying a first set of rules to each component as said each component is added to said representation to automatically configure said each component with respect to said rack.

2. The method for configuring a rack assembly as recited in claim 1, wherein when said rack is populated with a desired set of components resulting in a rack configuration, validating said rack configuration including all selected components added to said representation of said rack in said workspace.

3. The method for configuring a rack assembly as recited in claim 2, wherein said applying said first set of rules includes verification of a particular individual component's position within said rack.

4. The method for configuring a rack assembly as recited in claim 2, wherein said applying said first set of rules includes verification of a parent-child relationship associated with a particular individual component being added to said rack.

5. The method for configuring a rack assembly as recited in claim 2, wherein said validating said configuration of said rack includes invoking a second set of rules.

6. The method for configuring a rack assembly as recited in claim 5, wherein said second set of rules includes inter-component compatibility rules.

7. The method for configuring a rack assembly as recited in claim 5, wherein said second set of rules includes verification of a higher order parent-child relationship.

8. The method for configuring a rack assembly as recited in claim 5, wherein said first and second sets of rules are stored in a database associated with a rack configuration application server node accessed by said computer system via a computer network.

9. The method for configuring a rack assembly as recited in claim 5, wherein violation of at least one of said first and said second set of rules generates an error message.

10. The method for configuring a rack assembly as recited in claim 5, wherein said first and second sets of rules comprise at least one of human ergonomic constraints, form factor constraints, component weight-based constraints, power consumption constraints, thermal output constraints, component functionality constraints, and component compatibility constraints.

11. The method for configuring a rack assembly as recited in claim 2, wherein said catalog includes a rack catalog portion and a component catalog portion.

12. The method for configuring a rack assembly as recited in claim 11, wherein said component catalog portion includes components comprising at least one of servers, blades, storage systems, keyboards, display monitors, power supplies, and input/output (I/O) devices.

13. The method for configuring a rack assembly as recited in claim 11, wherein said rack catalog portion includes racks of different sizes and form factors.

14. The method for configuring a rack assembly as recited in claim 11, wherein said rack catalog portion includes racks from different manufacturers.

15. The method for configuring a rack assembly as recited in claim 11, wherein said component catalog portion includes components from different manufacturers.

16. The method for configuring a rack assembly as recited in claim 11, wherein at least one of said rack catalog portion and said component catalog portion is stored in a database associated with a rack configuration application server node accessed by said computer system via a computer network.

17. The method for configuring a rack assembly as recited in claim 1, further comprising:
identifying said configuration using a unique identity (ID) parameter; and
storing said configuration in a database for future retrieval based on said unique ID parameter.

18. The method for configuring a rack assembly as recited in claim 1, further comprising: initiating an action to cause said rack to be purchased.

19. The method for configuring a rack assembly as recited in claim 1, wherein said drag and drop interface is effectuated using Dynamic HyperText Markup Language (DHTML).

20. A system for configuring a rack assembly with a computer system having a graphical workspace, comprising:
means for graphically selecting a rack from a catalog;
means for graphically populating said rack with at least one component selected from said catalog, wherein each selected component is dragged by an input device associated with said computer system and dropped on a representation of said rack; and
means for applying a set of rules as each selected component is added to said representation to automatically configure said each selected component.

21. The system for configuring a rack assembly as recited in claim 20, further comprising means operable upon populating said rack with a desired set of components resulting in a rack configuration, for validating said rack configuration including all selected components added to said representation of said rack in said workspace.

22. The system for configuring a rack assembly as recited in claim 21, wherein said means for applying said set of rules includes means for verifying a particular individual component's position within said rack.

23. The system for configuring a rack assembly as recited in claim 21, wherein said means for applying said set of rules includes means for verifying a parent-child relationship associated with a particular individual component being added to said rack.

24. The system for configuring a rack assembly as recited in claim 22, wherein said means for validating said configuration of said rack includes means for invoking inter-component compatibility rules.

25. The system for configuring a rack assembly as recited in claim 21, wherein said means for validating said configuration of said rack includes means for verifying a higher order parent-child relationship.

26. The system for configuring a rack assembly as recited in claim 20, further comprising means for causing said rack to be purchased.

27. The system for configuring a rack assembly as recited in claim 20, wherein said means for graphically populating said rack comprises a drag and drop interface.

28. A computer-accessible medium having program code instructions thereon for facilitating, when executed by an application server, an automated scheme for configuring one or more rack assemblies, said computer-accessible medium comprising:
program code instructions for providing a drag and drop display interface to a user operating a client computer to which said application server is coupled via a computer network, wherein a graphic display window associated with said client computer includes a workspace in which a representation of a selected rack is populated by one or more components dragged and dropped by said user from a catalog display area; and
program code instructions for applying a set of rules as each selected component is added to said selected rack's representation in said workspace to automatically configure said each selected component.

29. The computer-accessible medium as recited in claim 28, further comprising program code instructions for validating said selected rack's configuration including all selected components added to said representation of said selected rack in said workspace.

30. The computer-accessible medium as recited in claim 28, wherein said catalog display area includes icons corresponding to at least one of servers, blades, storage systems, keyboards, display monitors, power supplies, and input/output (I/O) devices.

31. The computer-accessible medium as recited in claim 28, further comprising program code instructions for effectuating a rack catalog display area for displaying icons that correspond to racks of different sizes and form factors, each being selectable by said user by dragging and dropping a rack icon into said workspace.

32. The computer-accessible medium as recited in claim 28, wherein said catalog display area is operable to display icons corresponding to at least one of a rack catalog and a component catalog stored in a database associated with said application server.

33. The computer-accessible medium as recited in claim 28, wherein said rules are stored in a database associated with said application server.

34. The computer-accessible medium as recited in claim 28, wherein said rules comprise at least one of human ergonomic constraints, form factor constraints, power consumption constraints, thermal output constraints, component weight-based constraints, component functionality constraints, and component compatibility constraints.

35. The computer-accessible medium as recited in claim 28, further comprising:
program code instructions for identifying said selected rack's configuration using a unique identity (ID) parameter provided by said user; and
program code instructions for storing said selected rack's configuration in a database associated with at least one of said client computer and said application server for future retrieval based on said unique ID parameter.

36. The computer-accessible medium as recited in claim 28, further comprising program code instructions for causing said rack to be purchased.

37. The computer-accessible medium as recited in claim 28, wherein said components include “0U” parts selectable from a component catalog.

38. A system for configuring a rack assembly with a computer system having a graphical workspace, comprising:
a configurator coupled to a catalog and operable to allow a user to:
graphically select a rack from a catalog; and
populate said rack with at least one component selected from said catalog, wherein each selected component is dragged and dropped onto a graphical representation of said rack,
wherein said configurator automatically applies a set of rules as each selected component is added to said rack representation to automatically configure said each selected component.

39. The system for configuring a rack assembly as recited in claim 38, wherein said set of rules are operable to verify a particular individual component's position within said rack.

40. The system for configuring a rack assembly as recited in claim 38, wherein said set of rules are operable to verify a parent-child relationship associated with a particular individual component being added to said rack.

41. The system for configuring a rack assembly as recited in claim 38, wherein said configurator includes a validator operable upon populating said rack with a desired set of components resulting in a rack configuration, for validating said rack configuration including all selected components added to said representation of said rack in said workspace.

42. The system for configuring a rack assembly as recited in claim 41, wherein said validator is operable to apply inter-component compatibility rules.

43. The system for configuring a rack assembly as recited in claim 41, wherein said validator is operable to verify a higher order parent-child relationship with respect to said set of components.
